(19) United States
(12) Patent Application Publication
(10) Pub. No.: US 2004/0104890 A1
(43) Pub. Date: Jun. 3, 2004

(54) Compact book and apparatus using print media

(75) Inventors: John Caldwell, San Jose, CA (US); Larry Lynch, Los Gatos, CA (US); L. James Marggraff, Lafayette, CA (US); Eric Thomas Shuler, Piedmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA

(21) Appl. No.: 10/654,874

(22) Filed: Sep. 3, 2003

Related U.S. Application Data
(60) Provisional application No. 60/408,986, filed on Sep. 5, 2002.
(60) Provisional application No. 60/463,872, filed on Apr. 18, 2003.

(51) Int. Cl. G09G 5/00

(52) U.S. Cl. 345/156

(57) ABSTRACT

Interactive books are disclosed. An example includes a front cover and a rear cover. At least one page is between the front and rear covers. A binder couples the front cover, the rear cover, and the at least one page together. An antenna is in the rear cover. A stylus is coupled to either the front or the rear cover, and an output device such as a speaker is coupled to the front or the rear cover.

### CROSS-REFERENCES TO RELATED APPLICATIONS

This application claims the benefit of U.S. Provisional Patent Application No. 60/408,986, filed on Sep. 5, 2002 and 60/463,872, filed on Apr. 18, 2003. These U.S. Provisional Patent Applications are herein incorporated by reference in their entirety for all purposes.

### BACKGROUND OF THE INVENTION

There are a number of apparatuses that make a book “interactive”. An example of one such interactive book apparatus is described in U.S. Pat. No. 5,485,176 to Ohara et al. One example in this patent includes a lower base portion and a pivotal back structure upon which an open book rests. The back structure contains electronics. A video monitor is in communication with electronics in the back structure. A stylus is used to select images on open pages in the book and some response is then seen on the video monitor.

While the above described book/apparatus is useful, there are a number of features which could be improved. For example, the exemplary book apparatus with a video monitor described in the above patent is bulky and difficult to transport. It would be desirable if a book apparatus could be less bulky, and easier to transport. Moreover, the book apparatus described in the above patent includes a number of expensive parts. It would also be desirable if the cost of the book apparatus could be reduced so that more people could use them. The cost of the apparatus described in the Ohara et al. patent is also expensive so that the apparatus is not readily adapted for wide-spread temporary use. For example, the cost and the size of the apparatus described above would likely not allow it to be used as a temporary or take home audio guide device for use in a museum or other public facility.

Another product that was developed for toddlers was called “My First LeapPad™”. This product included a platform that would support just one of the pages of a spiral book. A stylus was coupled to the platform, and it was possible to select words in the book using the stylus. While this product was also useful, the other page of the book that was not on the platform was not secured in any manner. Although this might be suitable for a child that uses the product on the floor or on a table, it would be difficult to use the product as, for example, a guide book in a museum by a visitor where the product is to be carried and used by the visitor. The other page of the base that was not supported by the platform could have a tendency to flop around, unsupported.

Embodiments of the invention address these and other problems.

### SUMMARY OF THE INVENTION

Embodiments of the invention include interactive apparatuses using print media. In some embodiments, the apparatus can be in the form of a book with electronics. In other embodiments, the apparatus can include a platform and a separate book.

One embodiment of the invention is directed to a book comprising: (a) a front cover; (b) a rear cover; (c) at least one page comprising a first page and a second page between the front and rear covers, wherein both the first page and the second page include print elements; (d) a binder coupling the front cover, the rear cover, and the at least one page, wherein the first page and the second page are capable of being displayed to the user at the same time; (e) an antenna in the rear cover, and where the front cover is free of an antenna; (f) a stylus coupled to either the front or the rear cover; and (g) an output device coupled to the front or the rear cover.

Another embodiment of the invention is directed to a book comprising: (a) a front cover; (b) a rear cover; (c) at least one page between the front cover and the rear cover; and (d) a binder coupling the front cover, the rear cover, and the at least one page, wherein the at least one page comprises a first page and a second page, and wherein the first page comprises a print element and wherein the second page comprises a selectable symbol, wherein the selection of the selectable symbol causes an output device to produce an output related to the print element.

Another embodiment of the invention is directed to a platform unit for use with a book including a rear cover and a front cover, the platform unit comprising: (a) a platform comprising a first side and a second side; (b) an electronic position location system; (c) an output device coupled to the platform; and (d) a recess at the first side of the platform for receiving the rear cover of the book, and a holding structure at the second side of the platform for holding the front cover or one or more pages of the book.

These and other embodiments of the invention are described in further detail below.

### BRIEF DESCRIPTION OF THE DRAWINGS

FIG. 1 shows a book according to an embodiment of the invention in an open position.

FIG. 2(a) shows a book of the type shown in FIG. 1 in a closed position.

FIGS. 2(b) and 2(c) show a book of the type shown in FIG. 1 in a closed position with different closing mechanisms.

FIG. 3 shows an apparatus that includes a platform and a book on the platform.

FIG. 4 shows a platform of the type shown in FIG. 3 from a rear perspective view.

FIG. 5 shows a platform of the type shown in FIG. 4 with a book in an open position.

FIG. 6 shows an apparatus including a book on a platform from a front perspective view. The book is wrapped around the platform.

FIG. 7 shows an apparatus including a book on a platform from a back perspective view. The book is wrapped around the platform.

FIG. 8 shows a cross-sectional view of an apparatus with a book. The book is in a horizon orientation. This Figure also shows that a cover part of the apparatus can be used as a stand or an easel-type structure.

FIG. 9 shows a cross-sectional view of a stylus over a stack of pages.

FIG. 10 shows a block diagram of some electronic components that can be used in the book shown in FIGS. 1 and 2, and also in the apparatus shown in FIG. 3.

In the Figures, like numerals designate like elements.

### DETAILED DESCRIPTION

Embodiments of the invention are directed to books with electronics in them, as well as platform units that can be used with books. Other embodiments of the invention are directed to books that are specifically adapted for use with platform units. In these other embodiments, a combined platform unit and book can form an interactive apparatus.

Embodiments of the invention can be used in different ways. For example, embodiments of the invention can be used as: learning aids in schools, museum guides (e.g., paintings, souvenirs, zoo guides), reference guides (e.g., birds, astronomy, state parks), road guides (e.g., travel games, stories), medical guides (e.g., a book on how to treat asthma, dental information, and a nutritional guide), promotional materials (e.g., car care guides, owners' manuals), language guides (e.g., quick guides which provide proper pronunciation), road maps (e.g., point to point, places of interest), cook books, music books, etc.

As used in this application, the term “book” includes a structure including a front cover, a rear cover, and at least one page between the front and rear covers. The front cover, the rear cover, and the at least one page are bound together with a binder. The binder may be a spiral binder, a ring binder, a tape binder, etc. The front and rear covers may be the same or different type of material, shape, and/or size than the at least one page between the front and rear covers. For example, the front and rear covers may be sheets of paper like the at least one page (e.g., like an informal newsletter or magazine). In another example, the front and/or rear cover may include electronics while the pages in between and the front cover do not contain electronics. As will be apparent from the description below, this will make the resulting apparatus less costly and more compact.

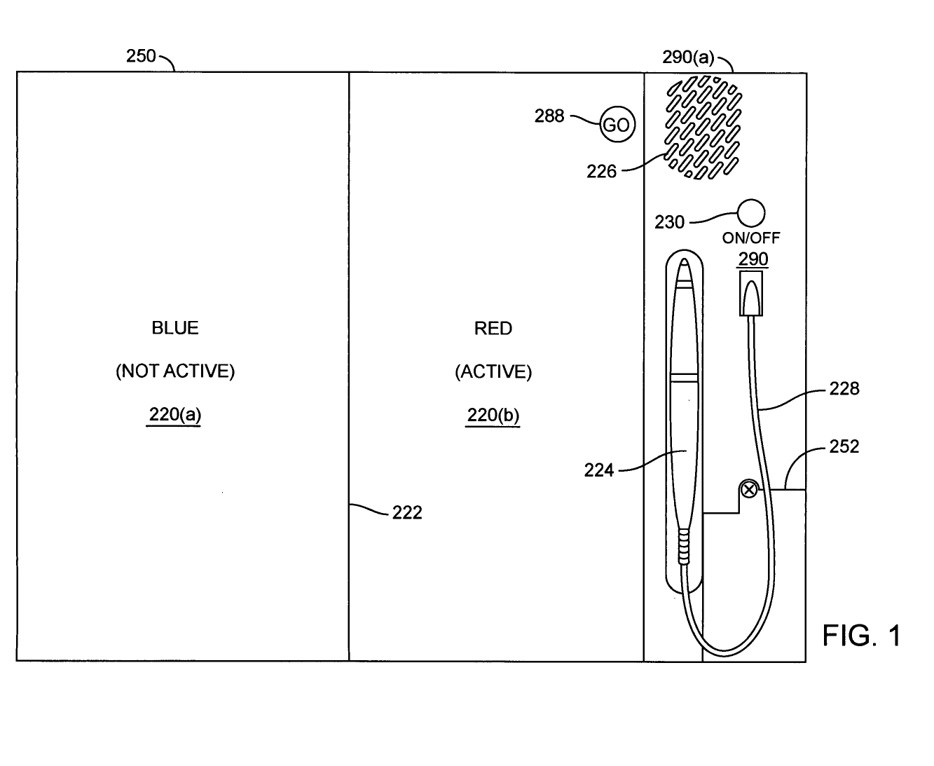

FIG. 1 shows an interactive book 250 according to an embodiment of the invention in an open position. In the embodiment of the invention shown in FIG. 1, the book 250 includes a front cover, a rear cover, and a number of pages in between. The rear cover of the book 250 includes electronics (e.g., an antenna, microprocessor, etc.), while the pages of the book 250 between the front and rear covers, and the front cover, do not contain electronics.

The rear cover 290 has a raised portion 290(a) that includes a speaker 226, and an on/off button 230. The speaker 226 can be a 36 mm, 16 ohm Mylar speaker with an internal magnet. A stylus 224 is attached to the rear cover 290 with a cable 228. The cable 228 may be 12 inches in length or less. A battery cover 252 is in the raised portion 290(a) of the rear cover 290. It can cover batteries (e.g., 4 AA, or AAA batteries) in a well in the raised portion 290(a).

The book 250 may comprise any suitable number of pages (e.g., one or more pages) between the covers. Preferably, the inner page or pages of the book 250 and the front cover of the book 250 do not contain electronics. In FIG. 1, a left page 220(a) and a right page 220(b) are displayed to the user. The left and right pages 220(a), 220(b) may correspond to first and second pages in some embodiments of the invention. The left and right pages 220(a), 220(b) are coupled together and to the rear cover 290 (and also a front cover—not shown) through a binder 222, which also coincides with the spine of the book 250. The binder 222 can permanently bind the pages and cover of the book 250 together so that a user cannot readily separate the pages of the book 250 from each other and from the covers of the book 250.

As illustrated by the parenthetical phrases “active” and “non-active” in FIG. 1, the left page 220(a) is not active while the right page 220(b) is active from the viewpoint of the user. For example, in this embodiment, a user may select the word “red” on the right page 220(b) using the stylus 224. In response, a synthesized voice saying the word “red” can sound from the speaker 226. If the user uses the stylus 224 to select the word “blue” on the left page 220(a), no audio output is produced. Even though the left and right pages 220(a), 220(b) are free of electronics, from a user perspective, the right page 220(b) is active while the left page 220(b) is not active. Both the left page 220(a) and the right page 220(b) contain printed matter. That is, an output is not produced when a print element on the left page 220(a) is selected with the stylus 224, but is produced when a print element on the right page 220(b) is selected with the stylus 224. Exemplary print elements include words, phrases, pictures, etc. printed on a sheet.

The output that is produced by the book may be a visual output and/or an audio output. Audio output is preferred as audio output can supplement and reinforce visual information in the book such as letters, pictures, and numbers. The combination of both audio output and visual information reinforces concepts that are taught by the interactive apparatus. Exemplary outputs can include letters, stories, numbers, words, phrases, jokes, music, questions, answers, prompts, sound effects, facts, etc. in visual or audio form.

In some embodiments, the output can be a prompt that asks the user for a response. For example, an exemplary question that the book might ask the user may be “Can you find the letter P?” In response, the user can select the letter P on a page in the book with the stylus. After the user responds, an output relating to the correctness or the incorrectness of the user's response can be provided to the user. For example, if the user's response is correct, a reward output (e.g., “that's right!”) can be provided to the user. If the response is incorrect, the question can be repeated or the user can be informed that the response was incorrect.

The output can have some relationship to the information conveyed by the print element or the nature of the print element. For instance, the output can relate to the identity, form, color, shape, or quality of a print element on a sheet. For example, after selecting a drawing of a frog on a sheet of paper with a stylus, the phrase “Hi, I'm Leap!” can be retrieved from memory and a speaker can sound the phrase to the user. Alternatively or additionally, the output can provide additional information about a particular print element. For example, a print element can be in the form of a state such as California. After the user interacts with the print element, information such as the population, the history, and/or the area of the state can be presented to the user.

Referring again to FIG. 1, one or more transmitting antennas (not shown) can be in the rear cover 290 and underneath the right page 220(b). A receiving antenna (not shown) can be in the stylus 224. Together with other electronics, they may form an electronic position location system. In this example, there would be no antenna underneath the left page 220(b). The receiving antenna in the stylus 224 receives a particular signal associated with one or more conductive fingers of one or more antennas. Other electronics (e.g., a microprocessor) in the rear cover 290 can determine the location selected by the user and can determine which print element on the right page 220(b) the user selects. The electronics in the rear cover 290 can then provide a specific output (e.g., audio output) that is related to the selected print element. Data for the various outputs can be stored in a memory unit (e.g., one or more ROM, EEPROM, chips, etc.) inside of the rear cover 290 or in a data cartridge (or other transferable information storage medium) that is coupled to the rear cover 290.

In FIG. 1, a “Go” circle 288 (or other page identifier) is at the edge of the right page 220(b), and can be selected to inform the electronics in the rear cover 290 as to which page or pages are currently being displayed to the user. The “Go” circle can be at different positions on the edge of other pages. Different antenna components (e.g., conductive fingers) underneath the differently located “Go” circles can provide different signals, which can be received by the receiving antenna in the stylus 224. A microprocessor in the rear cover 290 can then determine which page or pages of the book 250 are currently being displayed to the user so that appropriate outputs can be retrieved from memory and then played for the user.

The binder 222 permanently binds the pages, and the front and rear covers of the book 250 together. Suitable binders may include spiral spines, ring binder spines, taped spines, loop rings, double creased square spines, etc. The pages and the covers of the book 250 may be bound together using a suitable adhesive as many conventional books are bound together.

In this embodiment, the materials that are used to create the book 250 can comprise low cost materials such as cardboard, pressed paper, or low cost plastic. For example, in some embodiments, the external surfaces of the front and rear covers of the book 250 may be made of cardboard or other stiff, inexpensive material. The pages of the book 250 may be made of any suitable material including paper and polymeric sheets such as polyvinyl acetate sheets. The polymeric sheets may be non-transparent, transparent, or translucent.

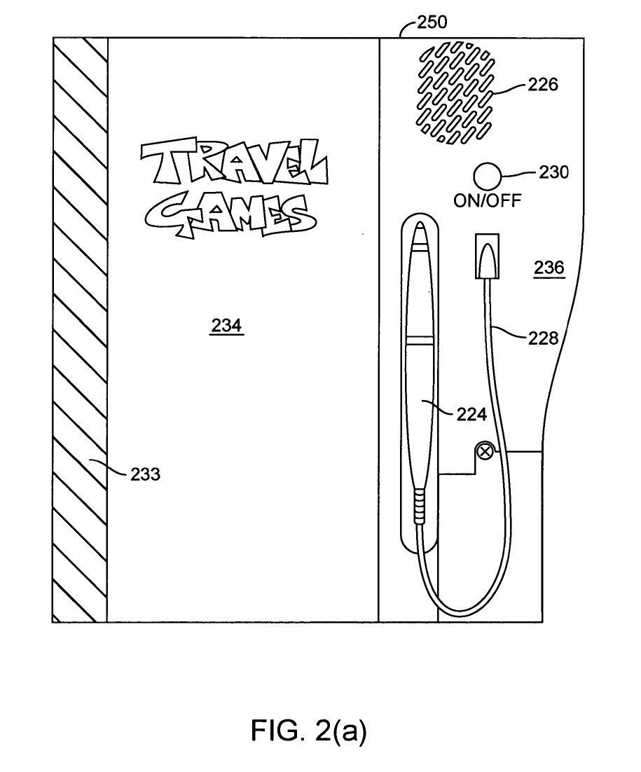

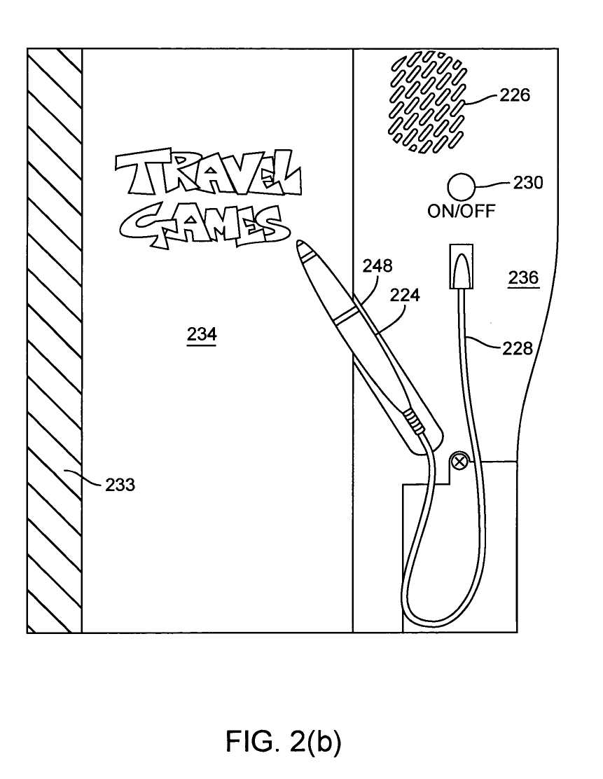

FIG. 2(a) shows the book 250 in a closed position. The book 250 has a front cover 234 and a binder 233 formed using an adhesive tape. As shown, the front cover 234 is smaller than the rear cover 236. This configuration also advantageously reduces the overall size of the apparatus. As is apparent from FIG. 2(a), the book 250 is one integral unit, and the user cannot easily separate the pages of the book 250 from the covers.

FIG. 2(b) also shows a book 250 in a closed position, except that the stylus 224 is in an angled recess 248. The cavity 248 is sized so that the stylus 224 “snaps” into the cavity 248. As shown, the stylus 224 is over the front cover 234 of the book 250 and keeps the book 250 closed so that the pages are secured together. This feature is useful as the stylus 224 can function as both a selecting device and a device which can hold the pages of the book 250 together in a closed position.

FIG. 2(c) shows another embodiment of the invention. In this Figure, the book has a closing assembly. The closing assembly includes a hole 292 and a flap 294 with a corresponding button. The flap 294 is attached to the raised portion of the rear cover 236. To close the book 250 and secure the pages of the book 250 together, the button on the flap 294 inserts into the hole 292 in the front cover and snaps together. Other book closing assemblies in other embodiments may include latches, hook and loop fasteners, tape, friction latches, detent latches, magnets, etc.

Other modifications to the previously described book are also possible. For example, in some embodiments, the speaker 226 may be shaped so that it extends outward with respect to the remainder of the rear cover 236, thus forming a protrusion. The stylus 224 and the cable 228 can be wrapped around the protrusion to keep it in place. In another example, it would be possible to use of a removable, flip cover as a “stand” to prop up the book when looking at content in horizon mode, as opposed to a vertical mode. These modifications are described in further detail below.

Further details regarding suitable styluses and also position location electronics can be found U.S. Pat. Nos. 5,877,458 and 5,686,705, and U.S. patent application Ser. No. 09/777,262, filed on Feb. 5, 2001, U.S. patent application Ser. No. 09/574,499, filed May 19, 2000, and U.S. patent application Ser. No. 10/222,205, filed on Aug. 16, 2002. Other suitable electronic position location apparatus are described in U.S. patent application Ser. No. 09/886,401, filed on Jun. 20, 2001, which is herein incorporated by reference in its entirety for all purposes. This patent application describes an array of pressure sensitive switches under a print medium on a platform. All of these patents and patent applications are herein incorporated by reference in their entirety for all purposes.

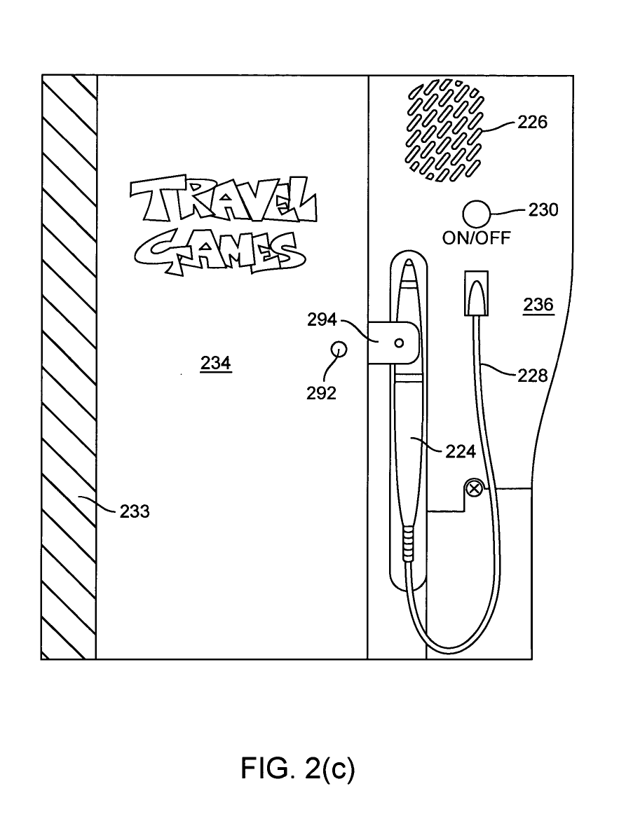

FIG. 3 shows another apparatus according to an embodiment of the invention. In this example, a book 302 is on a platform 320 of a platform unit. A removable apparatus cover 300 may be included in the platform unit. The apparatus cover 300 is attached to the platform 320 and helps secure the book 302 to the platform 320. A speaker 304 is in the platform 320 and a stylus 308 is attached to the platform 320. Clips 310 hold the stylus 308 in place when the stylus 308 is not being used. Other stylus holding structures such as rings could be used in other embodiments of the invention.

Together, the platform 320 and the stylus 308 may constitute a “platform unit”. However, in other embodiments, a platform unit may comprise a platform without a stylus (e.g., a pressure sensitive grid). Accordingly, in some embodiments, the platform unit may comprise only a platform while in other embodiments the platform unit may comprise a platform and other elements (e.g., a stylus and cable).

A cable 309 attaches the stylus 308 to the platform 320. The speaker 304 in the platform 320 can project upward from a major surface of the platform 320. When the stylus 308 is not in use, the cable 309 can wrap around the speaker 304. This is desirable as it also results in a more compact apparatus that can be easily stored.

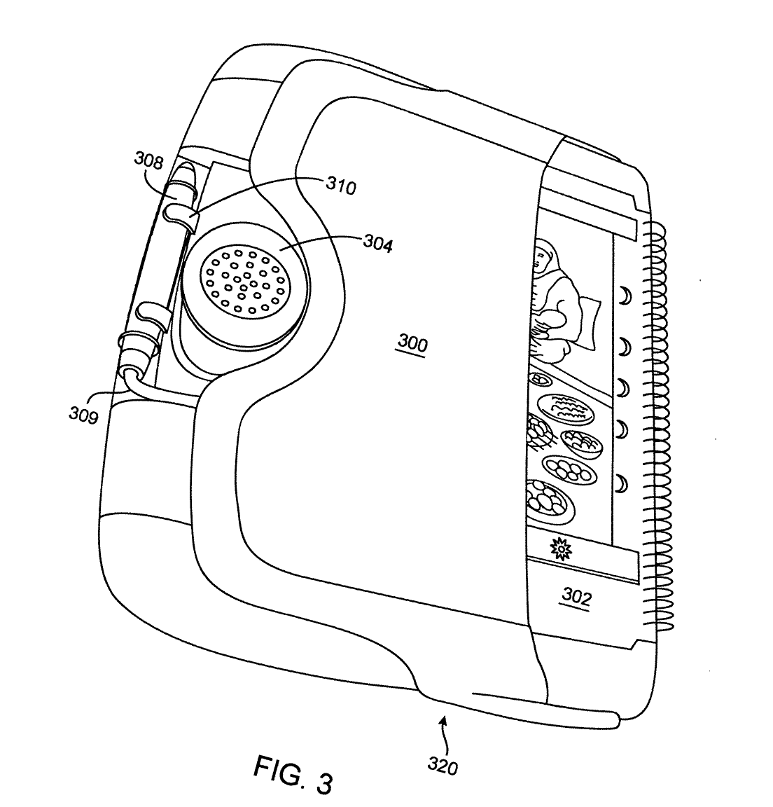

FIG. 4 shows the apparatus shown in FIG. 3 when the book is on a first side of the platform 320 from a bottom side perspective view. As shown, the underside of the platform 320 includes a back recess 332(b) at a second side of the platform 320 and is defined by borders. The back recess 332(b) receives the front cover and optionally one or more pages of the book 302. In this example, page holding structures 331 are present at the borders defining the recess 332(b). The page holding structures 331 in this example are in the form of rubber stoppers that hold the front cover of the book 302 and one or more pages that are not being viewed by the user securely to the platform 320. Other page holding structures may include, for example, clips. The page holding structures 331 desirably hold the pages of the book that are not being used to the platform 320 in a secure manner so that they are not loose.

A battery door 338 and a data cartridge 336 are also present in the platform 320. A side location 330 of the platform 320 includes power and/or headphone jacks so that power and/or headphone cords can be plugged in if desired.

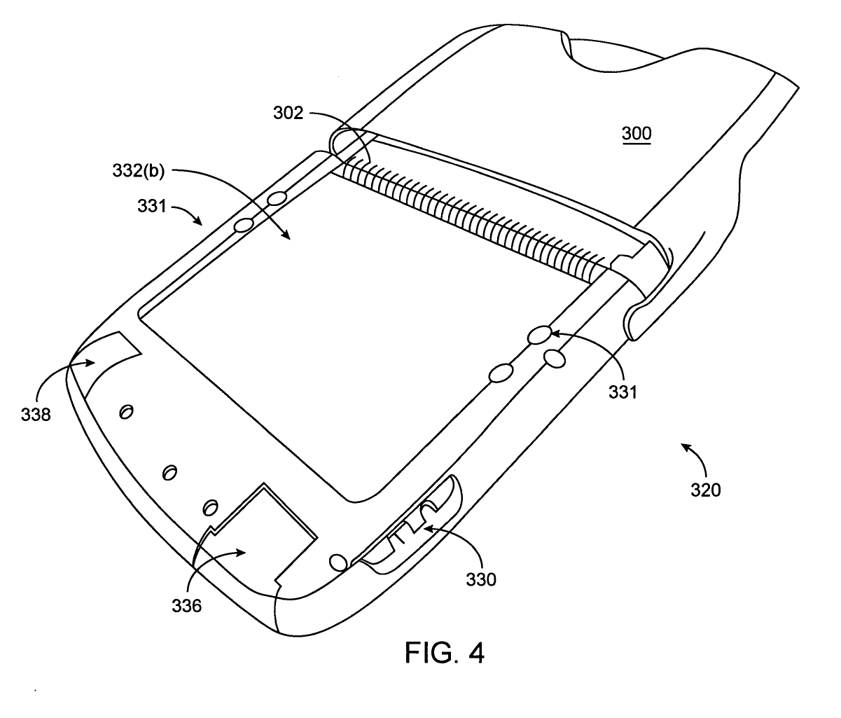

FIG. 5 shows the apparatus shown in FIG. 4 from a front perspective view. As shown, the book 302 has a front cover and one or more pages that are stacked in a front recess 332(a) defined by three borders.

The open pages of the book 302 include a left page 50(a) and a right page 50(b). The left page 50(a) and the right page 50(b) may respectively correspond to first and second pages in some embodiments of the invention. In this example, the right page 50(b) has print elements 40 in the form of Arabic text. The left page 50(a) has print elements in the form of images that are related to the Arabic text. Two language print elements 52, 54 are shown at the bottom of the right page 50(b) so that a user may select from either of these to cause the apparatus to read in an Arabic language or an English language mode. Volume control print elements 62, 64, a page indicating print element 66, and a stop print element 68 are shown at the border of the left page 50(a). The left and right pages 50(a), 50(b) may be bound together at a binder region 44. The pages 50(a), 50(b) have a number of perforations for a spiral wire to pass through (e.g., for a spiral spine).

In this example, the left page 50(a) is “active” while the right page 50(b) is “inactive”. The left page 50(a) includes a number of selectable symbols 48 in the form of crescent moons associated with the print elements 40 on the right page 50(b). When a user selects a selectable symbol 48 on the left page 50(a), an audio output relating to a print element 40 on the right page 50(b) is produced. For example, by selecting one of the crescent moon selectable symbols 48 (with the previously described stylus), audio corresponding to the text directly to the right of the selected crescent moon symbol 48 is produced. For example, the sentence directly to the right of the selected cresent moon symbol 48 can be read by a synthesized voice.

To assist the user, a number of directors 42 in the form of arrows are shown on the left page 50(a) to show the user that selecting a particular crescent moon selectable symbol 48 will produce an audio output related to the indicated sentence. In embodiments of the invention, the directors 42 may be printed symbols (e.g., arrows, lines, etc.) that visually link a selectable print element on a first page to a print element on a second page. The directors 42 according to embodiments of the invention may be on the page with the selectable symbol or on the page with the print element. In this example, the directors 42 are used, because there are no electronics under the right page 50(b). The directors 42 allow for two pages of a book to be used, while only one page is actually active. This allows two pages of a book to be functional, without requiring electronics under both pages.

Although the book 302 including pages 50(a) and 50(b) in FIGS. 3-5 does not contain electronics, it is understood that the pages 50(a) and 50(b) could be used in a book of the type shown in FIGS. 1 and 2(a)-2(c).

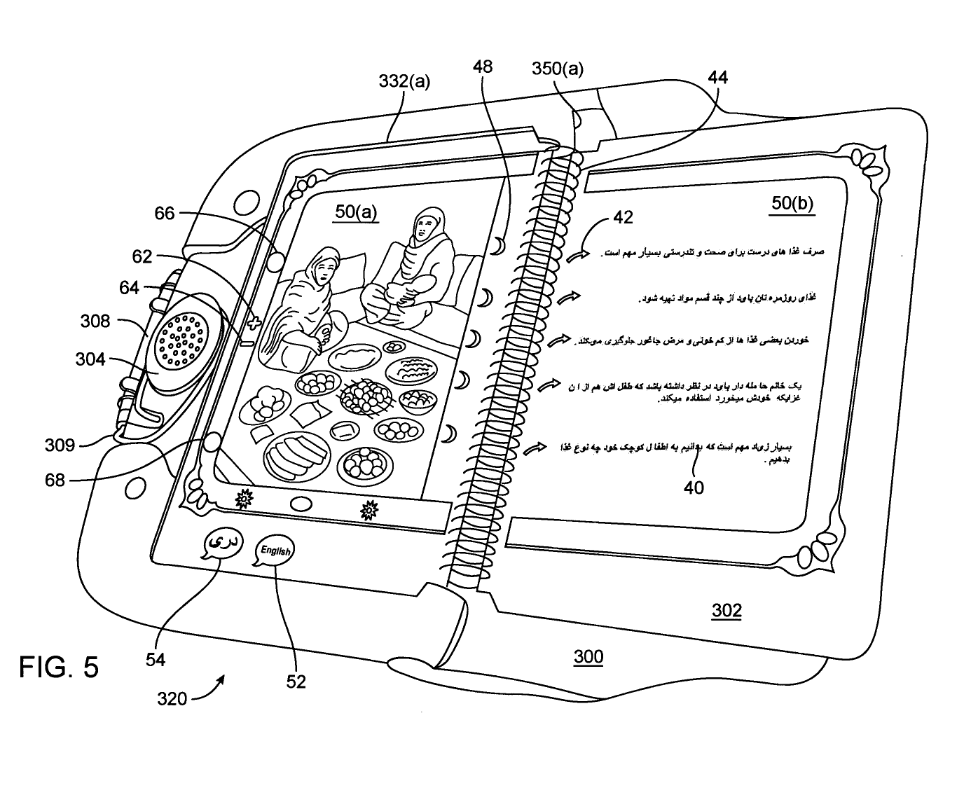

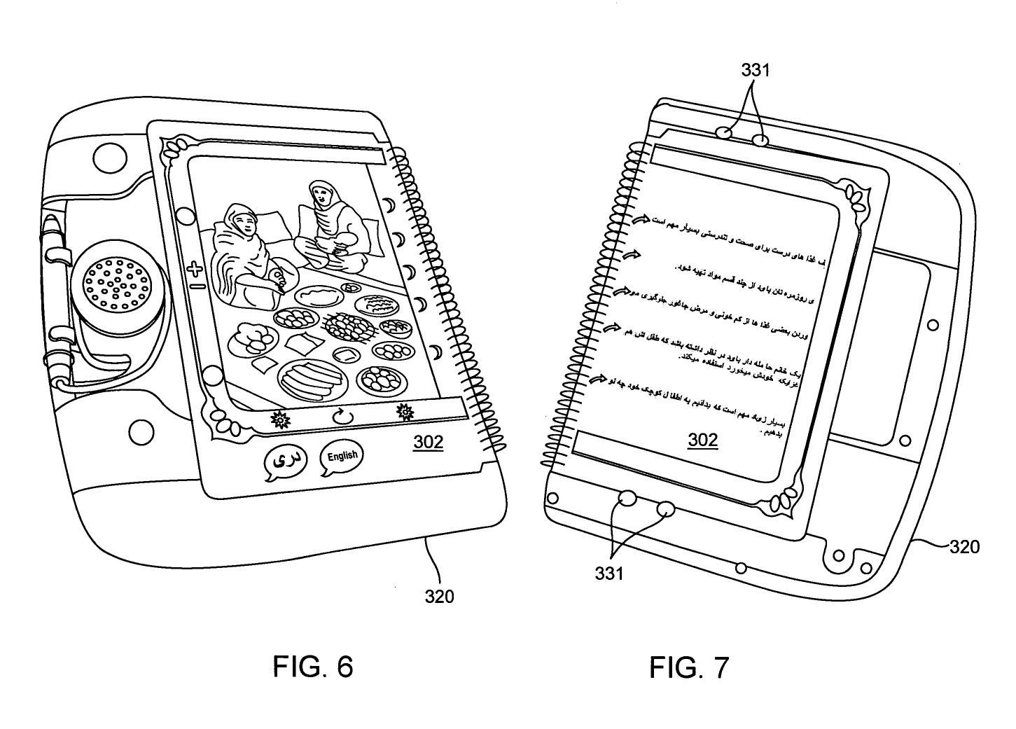

FIG. 6 shows a book 302 that is wrapped around the platform from a front perspective. FIG. 7 shows a book 302 that is wrapped around the platform 320 from a rear perspective. As shown in FIGS. 6 and 7, the apparatus is quite compact and is slightly larger than the size of a page of the book 302. The planar dimensions of the platform are less than twice the size of the page of the book 302. For example, in some embodiments, the book 320 may be about 4×6 inches in size and the platform may be only slightly larger than this. Page holding structures 331 hold pages of the book 302 to the platform 320.

In the example shown in FIGS. 6 and 7, the page shown in FIG. 6 is “active” from the viewpoint of the user while the page shown in FIG. 7 is not active. However, in other embodiments, both sides of the platform 320 could be active. For example, in some embodiments, both of the pages that are shown in FIGS. 6 and 7 can be active, if two sets of transmitting antennas radiate signals outwardly from the platform from opposite sides of the platform, and away from each other. Illustratively, in these two-way embodiments, two antenna elements (described in further detail below) can be arranged to radiate signals outward from opposite sides of the platform 320. A dielectric and a grounding conductor could be placed between the two outward radiating antenna elements so that signals from the two antenna elements do not interfere with each other. A stylus could thus be used to select print elements on both sides of the platform on two different pages. It is understood that this “two-way” radiating embodiment could be incorporated into the rear cover of the book that is described in FIGS. 1 and 2(a)-2(c).

Embodiments of the invention provide for a number of advantages. As shown by FIGS. 6 and 7, the apparatus is compact and uses fewer materials. Consequently, the apparatus can be made less expensively than comparable apparatuses that use platforms that make two open pages of a book “active”. If the housing of the platform is made of cardboard, then the cost of the apparatus can be further reduced. The cost of the apparatus may be low enough so that the apparatus and book can be considered a single use product in some embodiments. Also, because the apparatus is more compact, it is more portable than conventional apparatuses that function in the same manner. In addition, the pages of the book in the apparatus are secured to the platform so that they do not flop around or are otherwise loose. Lastly, as shown in FIGS. 6 and 7, a user may read text or view pictures on two pages of a book on a compact platform by looking at either side of the platform.

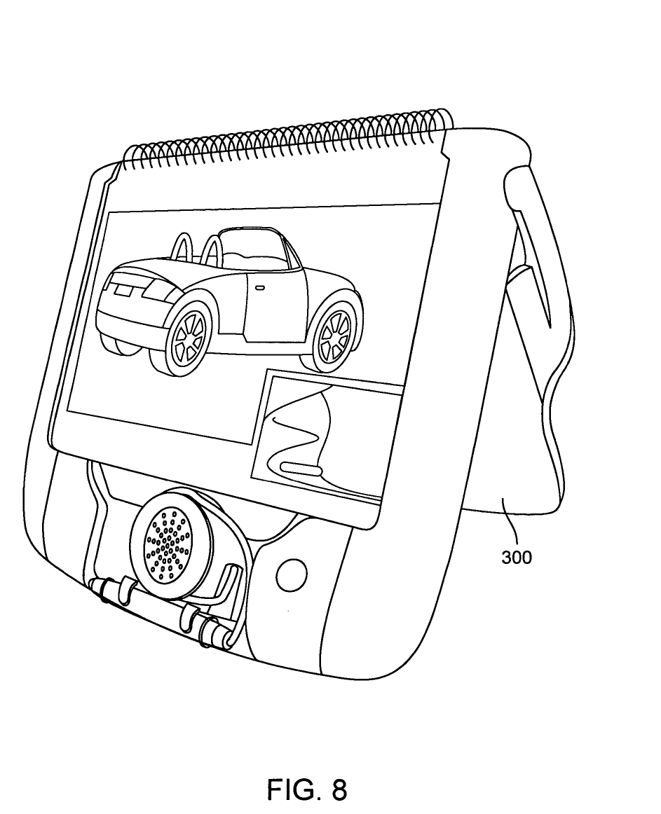

FIG. 8 shows how the platform supports a book in a horizon mode. The cover of the apparatus can act as one leg of a stand while the platform constitutes the other leg of the stand. A horizon mode can make it easier for the user to read or view the pages of the book. However, as noted above, other embodiments of the invention can also be used in a portrait mode where the pages of the book are viewed by the user in a portrait orientation.

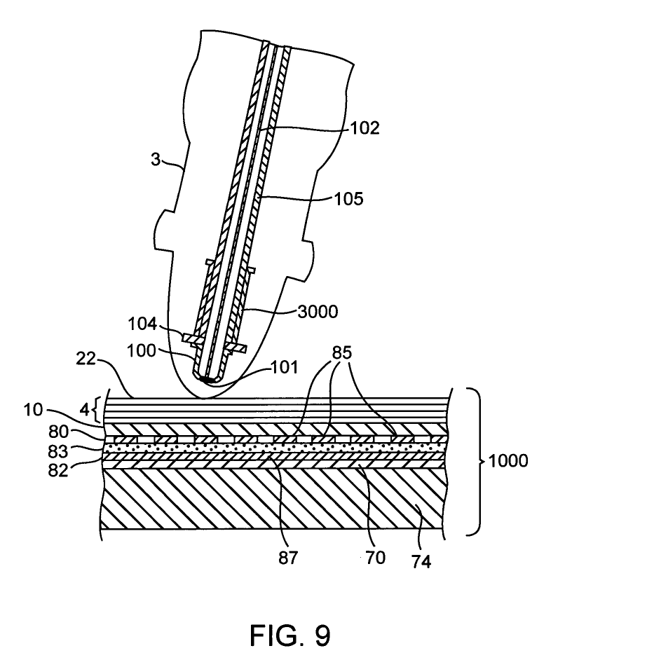

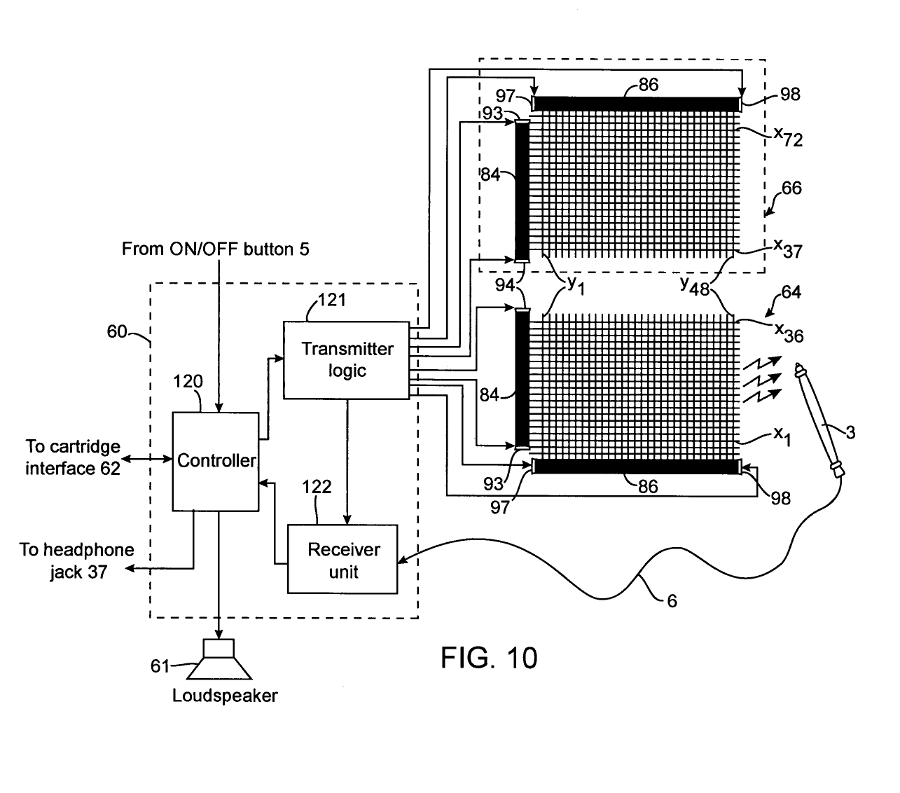

FIGS. 9 and 10 show some aspects of suitable electronics that may be in one or both covers of the above-described book (or in the platform unit).

FIG. 9 is a schematic cross section of the detection stylus 3 that is used for detecting an electromagnetic field generated by an antenna. The detection stylus 3 is shown resting on the surface of the pages 4 that lie on the upper section 10 of the rear cover 1000 of a book. Immediately beneath the upper section 10 of the rear cover 1000 lie the conducting fingers 85 of an upper antenna 80. These conductive fingers 85 are provided above an acetate insulating sheet 83 that separates the upper antenna 80 from a lower antenna 82. Disposed on the opposite side of the acetate sheet 83 are the conductive fingers 87 of a lower antenna 82. Beneath the lower antenna 82 lies a protective sheet of card 70 that it supported by a lower section 74 of the rear cover of the book.

Referring to both FIGS. 9 and 10, the distal end of the detection stylus 3 includes a brass ferule 100 that is connected via a solder bead 101 to a copper wire 102, which is connected via wire 6 to a processor 60. Provided at the end of the brass ferule 100 remote from the solder bead 101 is an insulating washer 104. The copper wire 102 extends through the center of this insulating washer 104. Shielding 105 extends within the detection stylus 3, the extent of the copper wire 102 to the insulating washer 104.

In some embodiments, a grounding conductor may be used to ground the user as the user may receive electromagnetic signals from the surrounding environment. A grounding contact may be added to the outer surface of the stylus 3 where the user grips the stylus 3. There may be an electrical connection from that grounding contact, to a conductive shield 105 in the stylus 3, and to a signal neutral point in the apparatus. By grounding the user during use, less noise is introduced into the system.

Alternating electric signals are applied via the electrical contacts 93, 94, 97, 98 to the resistive strips 84, 86 of the upper and lower antennas 80, 82. This causes an alternating electromagnetic field to be generated in the vicinity of the antennas 80, 82. This alternating electromagnetic field induces a voltage on the brass ferule 100 of the detection stylus 3 when the detection stylus 3 rests on the surface of the pages 4 adjacent to the antennas 80, 82. This electric signal is then passed via the wire 102 to the processor 60. The insulating washer 104 and shielding 105 prevent electrical signals from being induced within the wire 102 other than by variations in the electromagnetic field in the vicinity of the brass ferrule 100. A second ferrule 3000 can also be present. The second ferrule 3000 is adjacent to washer 104. The second ferrule 3000 may have a hat shape in order to reflect and shape the radiated signal from the underlying antenna to the first ferrule 100.

FIG. 10 shows a schematic block diagram of an electronic position location system. A processor 60 comprises a controller unit 120, transmitter logic 121, a receiver unit 122, and first and second antenna elements 64, 66 (which each may comprise two antennas in this example). In some embodiments, all of these electronics including the first and/or second antennas may be housed in the rear cover of a book. In other embodiments, only one of the first and second antenna elements 64, 66 may be housed in the rear cover of a book.

The processor 60 may include a signal driver and a signal processor. The controller unit 120 is connected via the transmitter logic 121 to antenna elements 64, 66. The controller unit 120 is also connected via the receiver unit 122 via the wire 6 to the detection stylus 3. The transmitter logic 121 and receiver unit 122 are also connected to each other directly. The controller unit 120 is also connected to the headphone jack 37, the loudspeaker 61, the cartridge mating interface 62 and the ON/OFF button 5.

When the ON/OFF button to the book is pressed, this is detected by the controller unit 120, which causes the transmitter logic 121 to be activated. The transmitter logic 121 then applies electric signals to the electrical contacts 93, 94, 97, 98 of the first antenna elements 64, 66 in a sequence of frames. In these frames, each lasting approximately 3 milliseconds, predetermined electrical signals are applied to the contacts 93, 94, 97, 98 of the transmitting antenna arrangements 64, 66. At the end of each frame a different set of signals are then applied to the contacts 93, 94, 97, 98.

The resistive strips 84, 86 may be resistive voltage dividers with resistors with different values, so that each conductive finger extending therefrom provides a signal at a different electrical potential. Each x-y position can have a different signal or signals associated with it, and these signals can be received by the antenna in the stylus 3.

In the course of a frame, electromagnetic fields are generated. These electromagnetic fields induce voltage potentials in the brass ferule 100 of detection stylus 3. This signal is then passed via the wire 6 to the receiver unit 122. In one example, the voltages applied to the contacts 93, 94, 97, 98 may range between plus three volts and minus three volts. The voltage induced within the brass ferule 100 (and also ferrule 3000) can be about 0.5 millivolts. The receiver unit 122 then processes the induced voltage and a processed signal is then passed to the controller unit 120.

The controller unit 120 then converts the processed signals received from the receiver unit 122 into signals identifying the coordinates of the portion of the page of the book 4 at which the detection stylus 3 is currently located. These coordinates are then used to select an appropriate sound stored within a sound memory either provided as part of the controller unit 120 or alternatively a sound memory provided as a memory chip within a cartridge inserted within the cartridge interface 62. The appropriate sound is then output via the loudspeaker 61 or to a set of headphones via the headphone jack 37.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed. Moreover, any one or more features of any embodiment of the invention may be combined with any one or more other features of any other embodiment of the invention, without departing from the scope of the invention.

All references, patent applications, and patents mentioned above are herein incorporated by reference in their entirety for all purposes. None of them are admitted to be prior art to the presently claimed inventions.

What is claimed is:

1. A book comprising:
(a) a front cover;
(b) a rear cover;
(c) at least one page comprising a first page and a second page between the front and rear covers, wherein both the first page and the second page include print elements;
(d) a binder coupling the front cover, the rear cover, and the at least one page, wherein the first page and the second page are capable of being displayed to the user at the same time;
(e) an antenna in the rear cover, and where the front cover is free of an antenna;
(f) a stylus coupled to either the front or the rear cover; and
(g) an output device coupled to the front or the rear cover.

2. The book of claim 1 wherein the antenna is a transmitting antenna.

3. The book of claim 1 wherein the output device comprises a speaker and wherein the stylus is coupled to the rear cover.

4. The book of claim 1 wherein at least one of the front cover or the rear cover comprises cardboard.

5. The book of claim 1 wherein the second page comprises a print element and wherein the first page comprises a selectable symbol, wherein the selection of the selectable symbol on the first page with the stylus causes the output device to produce an output related to the print element on the second page.

6. The book of claim 5 further comprising a director on the first page, which visually links the selectable symbol on the first page with the print element on the second page.

7. The book of claim 5 wherein the first page is on a left side of the book and the second page is on a right side of the book when the book is opened to the first and second pages.

8. The book of claim 1 wherein the output device is a speaker.

9. The book of claim 1 wherein the first page or the second page has print elements that are viewable in a horizon orientation.

10. The book of claim 1 wherein the rear cover comprises at least two radiating antennas that radiate signals outwardly from opposite sides of the rear cover.

11. The book of claim 1 wherein the binder comprises a spiral spine.

12. The book of claim 1 wherein the stylus is secured to the rear cover and is positioned so that the front cover does not open.

13. A book for use with a platform, the book comprising:
(a) a front cover;
(b) a rear cover;
(c) at least one page between the front cover and the rear cover; and
(d) a binder coupling the front cover, the rear cover, and the at least one page,
wherein the at least one page comprises a first page and a second page, and wherein the first page comprises a selectable symbol and wherein the second page comprises a print element, wherein the selection of the selectable symbol on the first page causes an output device in the platform to produce an output related to the print element on the second page.

14. The book of claim 13 further comprising a director on the first or second page, wherein the director visually links the selectable symbol and the print element.

15. The book of claim 13 wherein the output is an audio output.

16. The book of claim 13 wherein the print element includes words, and the output comprises the sounds of the words.

17. The book of claim 13 wherein the binder comprises a spiral spine.

18. The book of claim 13 wherein the book is free of electronics.

19. A book apparatus comprising:
(a) a stylus;
(b) a platform comprising a surface, wherein the stylus is coupled to the platform;
(c) a electronic position location system, including a first antenna in the platform and a second antenna in the stylus;
(d) an output device coupled to the platform; and
(e) the book of claim 13 on the surface.

20. The book apparatus of claim 19 wherein the at least one page comprises a right page and a left page, and wherein the first antenna is under the right page, but not the left page when the book is in an open position.

21. The book apparatus of claim 19 wherein the first antenna is a transmitting antenna.

22. The book apparatus of claim 21 wherein the at least one page comprises a right page and a left page, and wherein the first antenna is under the right page and under the left page when the book is in an open position.

23. A platform unit for use with a book including a rear cover and a front cover, the platform unit comprising:
(a) a platform comprising a first side and a second side;
(b) an electronic position location system;
(c) an output device coupled to the platform; and
(d) a recess at the first side of the platform for receiving the rear cover of the book, and a holding structure at the second side of the platform for holding the front cover or one or more pages of the book.

24. The platform unit of claim 23 wherein the electronic position location system comprises a first transmitting antenna in the platform and a second receiving antenna in the stylus.

25. The platform unit of claim 23 wherein the output device is a speaker.

26. The platform unit of claim 23 wherein the recess is cooperatively structured to receive the rear cover of the book.

27. The platform unit of claim 23 further comprising a stylus coupled to the platform and wherein the electronic position location system includes a first antenna in the stylus and a second antenna in the platform.

28. The platform unit of claim 23 further comprising a second recess at the second side.

29. The platform unit of claim 28 wherein the holding structure is at a border defining the second recess.

30. The platform unit of claim 23 wherein the platform has a planar area that is less twice an area of the rear cover.

31. The platform unit of claim 23 wherein the platform has at least two antennas, wherein the two antennas radiate signals outwardly from the platform in opposite directions from the first and second sides of the platform.
